(19) United States
(12) Patent Application Publication
(10) Pub. No.: US 2014/0020538 A1
(43) Pub. Date: Jan. 23, 2014

(54) VEGETABLE CUTTING APPARATUS

(71) Applicant: Hideo MATSUMOTO, Saitama-shi (JP)

(72) Inventor: Hideo MATSUMOTO, Saitama-shi (JP)

(21) Appl. No.: 13/772,037

(22) Filed: Feb. 20, 2013

(30) Foreign Application Priority Data
Jul. 17, 2012 (JP) 2012-158380

(51) Int. Cl. B26D 1/12

(52) U.S. Cl. CPC B26D 1/12
USPC 83/416

(57) ABSTRACT

A vegetable cutting apparatus which includes a rotation driving unit, a cutting unit, and a feeding unit having a vegetable intermittent feeding device; the feeding unit is provided with a drive roller and a driven roller which are installed across side walls horizontally extending from the cutting unit, a conveyor belt which is installed between both rollers, and a holding roller which is disposed above the conveyor belt on the rear side thereof with a clearance to the conveyor belt being held; and a oneway clutch is mounted to the drive roller such that, with rocking turning thereof, the drive roller is intermittently rotation-driven, thereby the vegetables placed on the conveyor belt being intermittently fed, and at the time of cutting operation, feeding of the vegetables can be stopped.

### TECHNICAL FIELD

The present invention relates to a vegetable cutting apparatus, and more particularly to a vegetable cutting apparatus for continuously cutting long green onions, onions, carrots, burdocks, and other vegetables, fruits, and mushrooms and other foodstuffs (hereinafter to be simply referred to as “vegetables”) to a desired size.

### BACKGROUND ART

Not only in the foodstuff factories, bento factories, supermarkets, and restaurants, but also in recent years, in the eating-out chain restaurants, the cut articles of vegetables are being demanded in quantity, however, making an operation of cutting the vegetables manually in response to such demands is, of course, non-efficient, and thus will never make any significant profit. Then, in order to meet such demands, the present inventor has proposed various apparatuses which can efficiently perform a cutting operation on vegetables with a relatively simple mechanism, and has made them into products (Patent Literature 1: Japanese Patent No. 3817588 and Patent Literature 2: Japanese Unexamined Patent Application Publication No. Hei 8-281591).

However, many of the apparatuses which have been conventionally proposed use a scheme in which vegetables to be cut are forced into a guide in the shape of a cylinder by hand, and with them, there have presented a problem that the vegetable feed pressure on the blade is non-uniform, which tends to cause the size of the cut products to be non-uniform, and a problem that, also at the time of cutting, the feed pressure continues to be applied to the blade, thereby smooth cutting assuring a neat cut end cannot be performed. Further, with them, there has been another problem that the respective unit components of the apparatus are connected to one another by screwing, bolting, and the like, thereby disassembling/reassembling the apparatus in making cleaning, or the like, becomes a time-consuming operation.

A vegetable cutting apparatus must be provided with which, since no feed pressure is applied at the time of cutting, smooth cutting giving a neat cut end can be performed, and disassembling/reassembling in cleaning, or the like, can be made with ease.

### CITATION LIST

### Patent Literature

[Patent Literature 1] Japanese Patent No. 3817588

[Patent Literature 2] Japanese Unexamined Patent Application Publication No. Hei 8-281591

### SUMMARY OF INVENTION

### Technical Problem

As described above, conventional vegetable cutting apparatuses have faced problems that the vegetable feed pressure on the blade is non-uniform, which tends to cause the size of the cut products to be non-uniform, that, also at the time of cutting, the feed pressure continues to be applied to the blade, thereby smooth cutting assuring a neat cut end cannot be performed, and further that the respective unit components of the apparatus are connected to one another by screwing, bolting, and the like, thereby disassembling/reassembling the apparatus in making cleaning, or the like, becomes a time-consuming operation.

Then, it is an object of the present invention to provide a vegetable cutting apparatus which eliminates such problems, in other words, a vegetable cutting apparatus with which the vegetable feed pressure on the blade is uniform, whereby the size of the cut products can be made uniform; no feed pressure is applied to the blade at the time of cutting, whereby smooth cutting assuring a neat cut end can be performed; further, the respective unit components of the apparatus can be connected to one another with no need for screwing, bolting, and the like, whereby disassembling/reassembling the apparatus in making cleaning, or the like, can be performed with ease; and in addition, the size of the cut products can be altered during the running of the vegetable cutting apparatus.

### Solution to Problem

In order to solve the above-described problems, the invention in accordance with claim 1 provides a vegetable cutting apparatus, including: a rotation driving unit having a rotation driving means; a cutting unit having a cutting means for cutting charged vegetables, being planetary gear-driven by the rotation driving means; and a feeding unit having an intermittent feeding means for intermittently supplying the vegetables to be cut to the cutting means,

the feeding unit having a conveyor frame horizontally extending from the cutting unit; a drive roller and a driven roller, being installed across side walls of the conveyor frame; a conveyor belt, being installed on the drive roller and the driven roller in a tightened state; and a holding roller, being disposed above the conveyor belt on the rear side thereof with a clearance to the conveyor belt being held,

to the drive roller, a oneway clutch being mounted, and with rocking turning of a rocking bar disposed on the oneway clutch, the drive roller being intermittently rotation-driven, thereby the vegetables placed on the conveyor belt being made intermittently feedable toward the cutting means, and feeding of the vegetables at the time of cutting operation by the cutting means being made stoppable.

In one embodiment, the middle portion of the rocking bar is connected to the oneway clutch, the inner end portion of the rocking bar being always pulled upward by a tension spring to be abutted against a drive bar, the drive bar being rocked by following a plate cam fixed to an output shaft of the rotation driving means, and the rocking bar being rocked about the shaft of the oneway clutch as the drive bar being rocked, thereby being engaged with the drive roller at the time of rocking in one direction for intermittently moving the conveyor belt. The plate cam functions such that, at the time of cutting operation by the cutting means, advancement of the conveyor belt is stopped.

In another embodiment, along a side wall on the side opposite to the side of the conveyor frame on which the rocking bar is disposed, an auxiliary conveying mechanism is disposed such that, through the auxiliary conveying mechanism, an intermittent rotation operation of the driven roller is transmitted to the holding roller.

In another embodiment, on the side wall on the side on which the rocking bar is disposed, an adjuster in the shape of a sector having a peripheral face in the shape of a circular arc that is abutted against a back face of the rocking bar in the front portion thereof, and being eccentrically pivoted is disposed, and by eccentrically pivoting the adjuster, the rocking region for the rocking bar is adjustable.

In another embodiment, a seizing member which, in one end portion, is provided with a folded piece to slidably engage with a rectangular hole formed in the side wall, and in the other end portion, is provided with a seizing hole for seizing one end portion of a leaf spring to be disposed across the tip portions of the side walls, and in which, in the middle portion, a shaft supporting groove for seizing the shaft of the driven roller is formed is disposed along the side wall, and the shaft of the driven roller is pulled through the seizing member by the function of the leaf spring, thereby the tightened state of the conveyor belt is capable of being maintained.

### Advantageous Effects of Invention

The present invention is as described above, offering advantages that the vegetables which have been supplied to the cutting unit are automatically fed at a constant pressure, being sandwiched between the conveyor belt, which is intermittently moved in a circulatory manner, and the holding roller, which is intermittently rotated in synchronization with the conveyor belt, thereby the vegetable feed pressure applied to the blade being uniform, and thus the size of the cut products being uniform, and in addition, the intermittently operated conveyor belt and the holding roller stop their operations at the time of cutting operation by the round blade with no feed pressure being applied to the round blade at the time of cutting, whereby smooth cutting assuring a neat cut end can be performed.

Further, with the vegetable cutting apparatus in accordance with the present invention, there is obtained an advantage that it is possible to use a single rotation driving means for making driving of the cutting means and feeding of the vegetables in the feeding unit, whereby the entire apparatus can be configured to be compact; with the invention in accordance with claim 4, there is obtained an advantage that, by operating the adjuster, the size of the cut products can be altered during the running of the vegetable cutting apparatus; and with the invention in accordance with claim 5, there is obtained an advantage that no means such as screws and bolts are used for connecting the respective components of the apparatus, whereby disassembling/reassembling in cleaning, or the like, can be made with ease.

### BRIEF DESCRIPTION OF DRAWINGS

FIG. 1 is a perspective view illustrating the appearance of one embodiment of a vegetable cutting apparatus in accordance with the present invention;

FIG. 2 is a longitudinal sectional view of one embodiment of the vegetable cutting apparatus in accordance with the present invention;

FIG. 3 is a side view of one embodiment of the vegetable cutting apparatus in accordance with the present invention;

FIG. 4 is a front view of one embodiment of the vegetable cutting apparatus in accordance with the present invention;

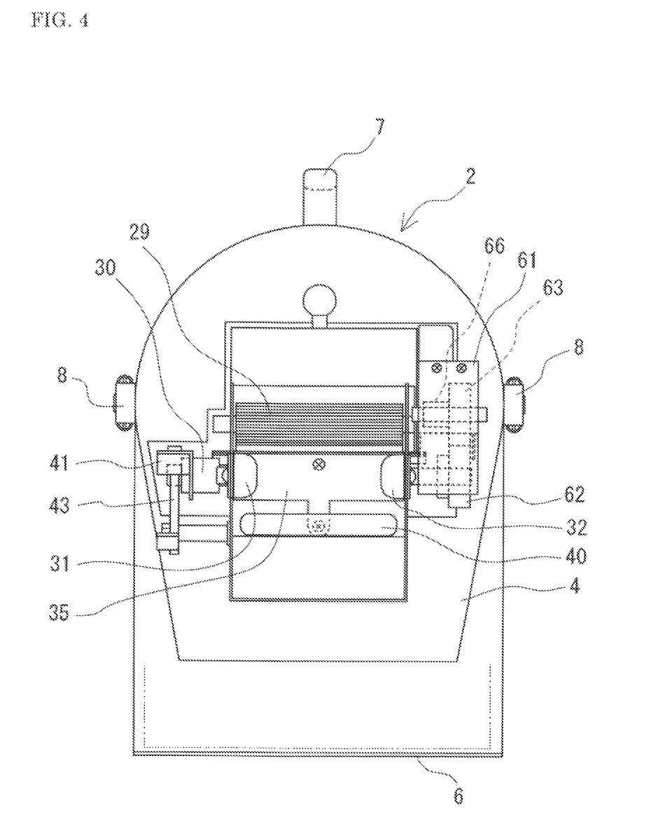

FIG. 5 is a figure illustrating the configuration of a vertical base plate portion of the vegetable cutting apparatus in accordance with the present invention;

FIG. 6 is an exploded perspective view illustrating the configuration of a feeding unit in the vegetable cutting apparatus in accordance with the present invention;

FIG. 7 is an exploded perspective view illustrating the configuration of a feeding unit in the vegetable cutting apparatus in accordance with the present invention;

FIG. 8 is a partially cutaway view illustrating the configuration of a planetary gear driving mechanism unit in the vegetable cutting apparatus in accordance with the present invention; and

FIG. 9 is an exploded perspective view illustrating the configuration of the feeding unit in the vegetable cutting apparatus in accordance with the present invention.

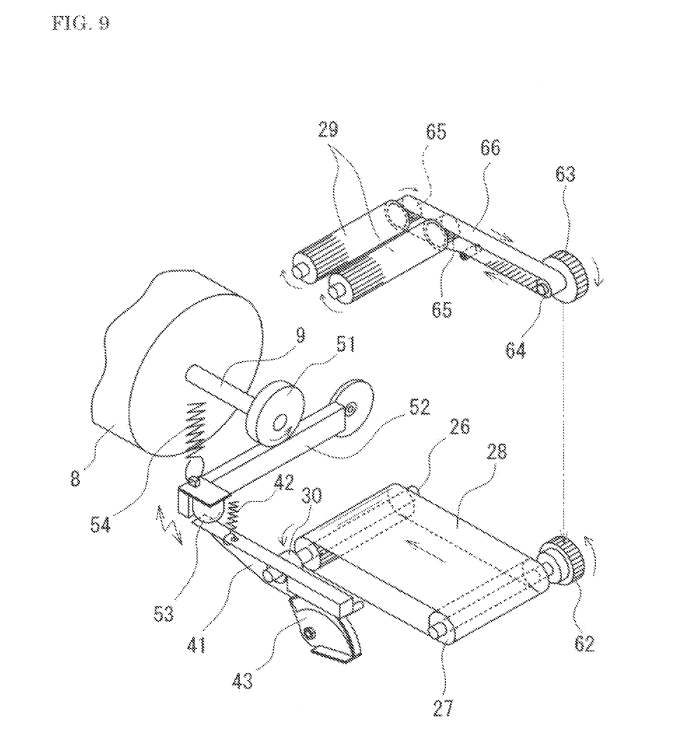

### DESCRIPTION OF EMBODIMENTS

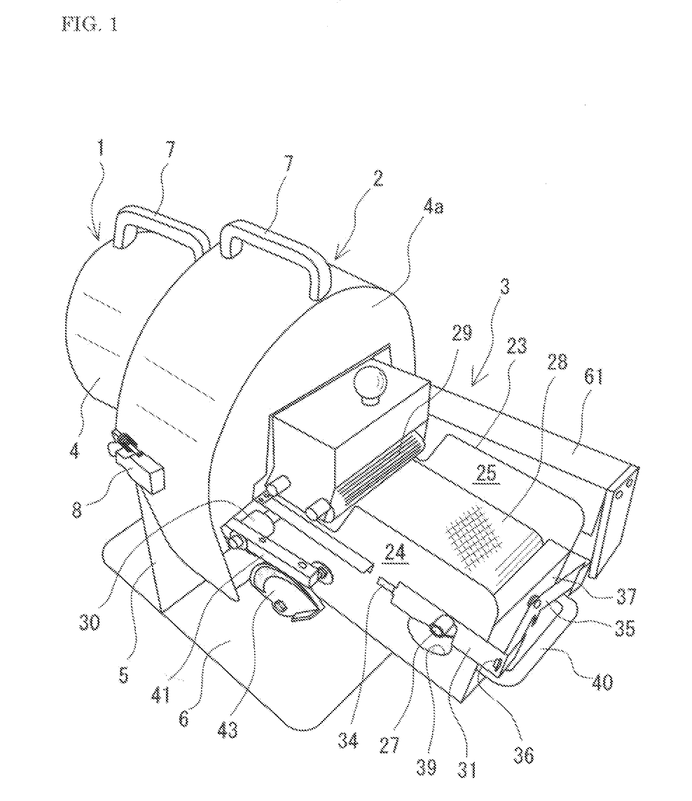

Hereinbelow, an embodiment of the present invention will be explained with reference to the accompanying drawings. FIG. 1 is a perspective view of one embodiment of an apparatus in accordance with the present invention, and the apparatus as shown in the figure includes a rotation driving unit 1 having a rotation driving means, a cutting unit 2 having a cutting means which is planetary gear-driven by the rotation driving means for cutting vegetables, and a feeding unit 3 having a feeding means for intermittently introducing the vegetables to be cut into the cutting unit 2.

The rotation driving unit 1 and the cutting unit 2 are accommodated in a casing 4, 4a. The casing 4, 4a is divided into two by a vertical base plate 5, the one casing 4 housing the rotation driving unit 1, and the other casing 4a housing the cutting unit 2. The vertical base plate 5 is fixed to the casing 4, and the casing 4a is detachably attached to the vertical base plate 5 through a connection metal fitting 8. The vertical base plate 5 includes a wide base plate 6, supporting the casing 4, 4a and the feeding unit 3 which is disposed on the casing 4a. On the casing 4, 4a, a handle 7 is disposed which is to be gripped in moving or disassembling the apparatus.

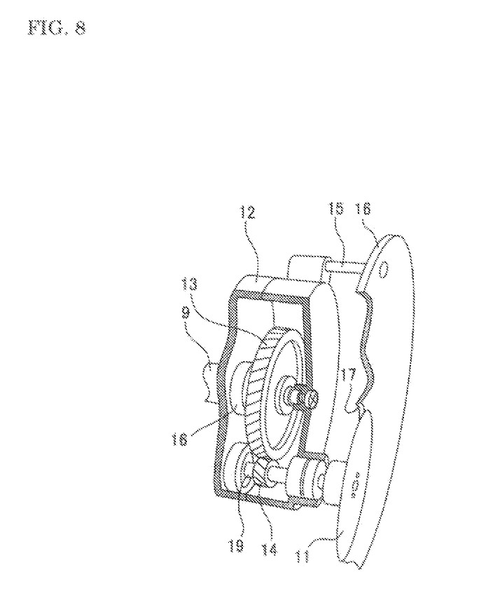

Generally, the rotation driving means in the rotation driving unit 1 is a motor 8, and the cutting unit 2 includes a round blade 11 for cutting vegetables, and a planetary gear driving mechanism which is disposed on an output shaft 9 of the motor 8 for planetary gear-driving the round blade 11. The planetary gear-driving mechanism includes a gear case 12 which is fixed to the output shaft 9 of the motor 8 to be integrally rotated, a sun gear 13 which is incorporated in the inside of the gear case 12, being fixed to a shaft extending in the inside of the output shaft 9, and a planetary gear 14 which is engaged with the sun gear 13, and the gear case 12 functions as an arm of the planetary gear-driving mechanism that connects between the sun gear 13 and the planetary gear 14 (see FIG. 8).

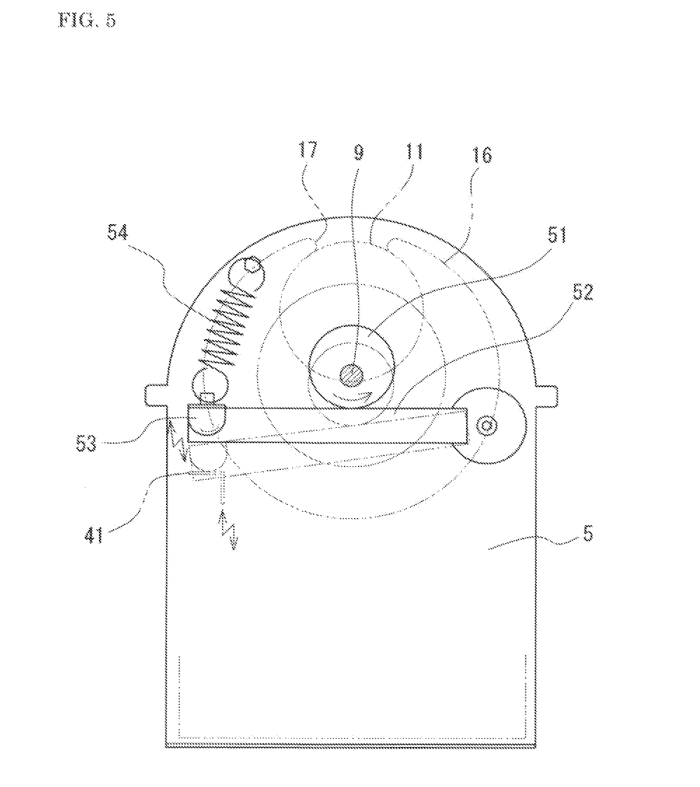

The round blade 11 is disposed such that it is housed in a circular opening 17 which is eccentrically formed in the rotation base plate 16, the rotation base plate 16 being mounted to the gear case 12 through a spacer 15, with an appropriate clearance being held between the round blade 11 and the inner edge portion of the circular opening 17. The vegetables which have been cut are passed through this clearance to be dropped off from a bottom portion opening in the casing 4a for being recovered into a recovery container. The rotation shaft 19 of the round blade 11 is supported in the inside of the gear case 12, and to that rotation shaft 19, the planetary gear 14 is fixed. The rotation base plate 16 may be formed to provide a crescent shape by adapting the circular opening 17 in the rotation base plate 16 so as to communicate with the outside of the rotation base plate 16 (see a virtual line in FIG. 5).

With this configuration, when the rotation driving force of the motor 8 is transmitted from the output shaft 9 thereof to the gear case 12, resulting in the rotation base plate 16, which is mounted to the gear case 12, being rotated integrally with the gear case 12, the rotation shaft 19 of the round blade 11 is rotated (revolved) about the output shaft 9. Then, since the planetary gear 14, which is mounted thereto, is engaged with the sun gear 13, which is fixed, the rotation shaft 19 is revolved, while being rotated in the same direction as that of revolution thereof at a high speed, for continuously cutting the vegetables which are fed by a conveyor belt 28. The above-described way of transmission of the rotation driving force is merely an example, and is, of course, not limited to this, and any configuration which can achieve the above-described rotation/revolution of the round blade 11 is applicable.

The feeding unit 3 includes a conveyor frame 23 which horizontally extends from the casing 4a; a drive roller 26 and a driven roller 27 which are installed across side walls 24, 25 of the conveyor frame 23, the conveyor belt 28, which is tightened, being installed on the drive roller 26 and the driven roller 27, and a holding roller 29, which is disposed above the conveyor belt 28 on the rear side thereof with a clearance to the conveyor belt 28 being held for passing the vegetables. Generally, two holding rollers 29 are provided, being placed in parallel. As described later, a oneway clutch 30 is mounted to the drive roller 26, and the function of that oneway clutch 30 causes the drive roller 26 to be intermittently rotation-driven, thereby the vegetables supplied onto the conveyor belt 28, which is driven by the drive roller 26, are intermittently fed toward the cutting means.

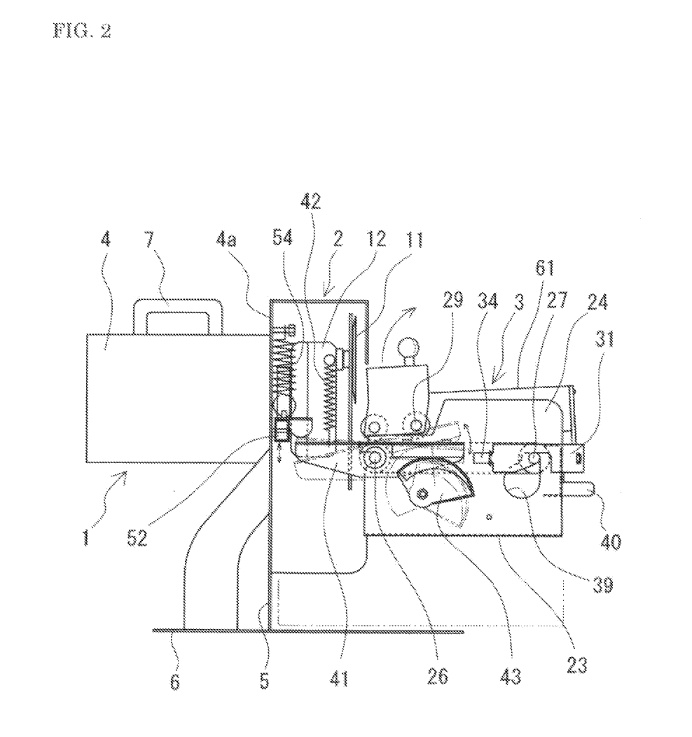

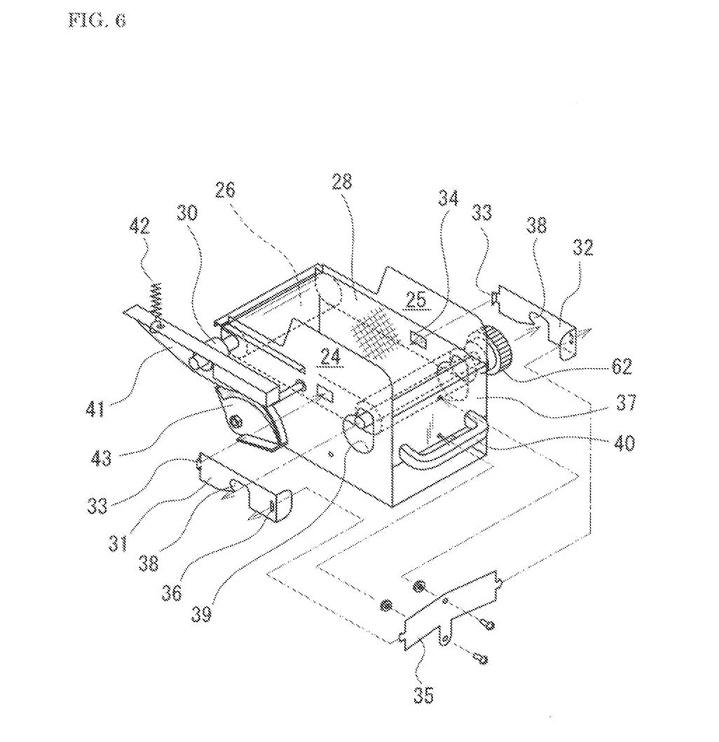

Along the outside face of the side walls 24, 25, a seizing member 31, 32 is disposed. The rear end portion (the left end portion in FIG. 2) of the seizing member 31, 32 is made narrower and folded to form a folded piece 33, and the folded piece 33 is slidably and engageably inserted into a rectangular hole 34, which is provided in the side walls 24, 25 (see FIG. 6). Further, in the front end portion of the seizing member 31, 32, a seizing hole 36 for seizing one end portion of a leaf spring 35 is formed. The leaf spring 35 gives a shape of the Hiragana letter ku when viewed from the top, and the angled contour portion in the middle thereof is fixed to a front plate 37 which connects between the front ends of the side walls 24, 25. Further, in the middle portion of the seizing member 31, 32, a shaft supporting groove 38 is formed, and therein, the shaft end portion of the driven roller 27 is housed and seized.

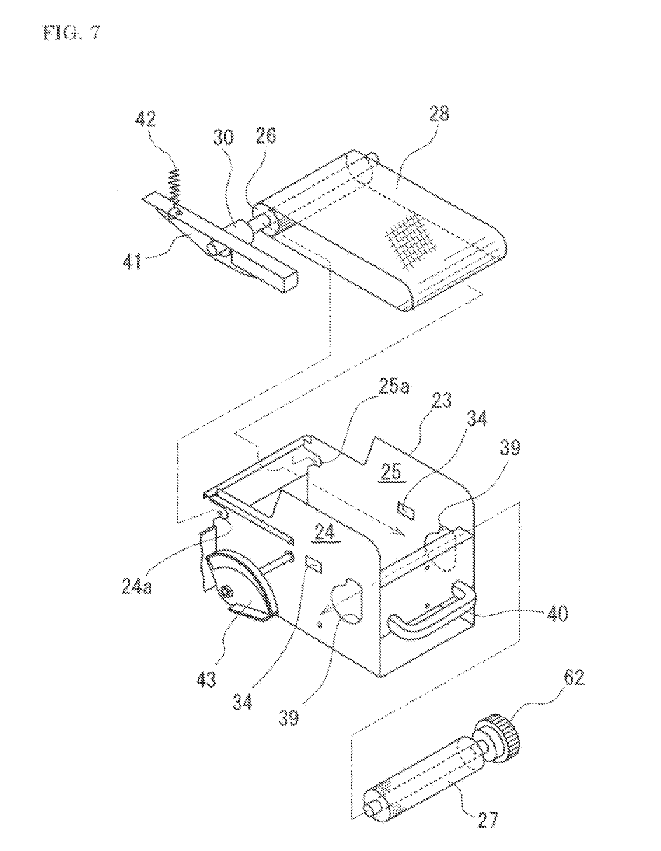

In the side walls 24, 25, an opening 39, which has a diameter sufficiently larger than that of the driven roller 27, is formed for inserting or withdrawing the driven roller 27 in disassembling/reassembling the vegetable cutting apparatus by the later-described method. The upper edge line of the opening 39 is formed linearly such that the shaft of the driven roller 27 can be horizontally moved in a crosswise direction (see FIG. 7). Further, in the rear end portion of the side walls 24, 25, a seizing groove 24a, 25a is formed, and therein the shaft end of the drive roller 26 is seized (see FIG. 7). The front plate 37 is provided with a handle 40 as needed.

In such a configuration, in the state in which the casing 4a is removed from the vertical base plate 5, the conveyor belt 28 into which the drive roller 26 has been inserted is loaded from the rear face side of the conveyor frame 23, and the shaft end of the drive roller 26 is engageably inserted into the seizing groove 24a, 25a of the side wall 24, 25. And, the driven roller 27 is inserted from the opening 39 in the side wall 24, 25 to be passed through the inside of the conveyor belt 28 in the loosened state, and both ends thereof are once placed on the edges of the openings 39.

Next, in the state in which the shaft end portion of the driven roller 27 is housed in the shaft supporting groove 38 in the seizing member 31, 32, the folded piece 33 at the rear end thereof is engageably inserted into the rectangular hole 34 of the side wall 24, 25, and one end portion of the leaf spring 35 is inserted into the seizing hole 36 in the seizing member 31, 32, while being pressed against the spring pressure of the leaf spring 35. In this way, the seizing member 31, 32 is brought into the state in which it is always pulled forward by the leaf spring 35, resulting in the driven roller 27 being always pulled forward, thereby the conveyor belt 28 is kept tightened, and the rotation of the drive roller 26 and the driven roller 27 is firmly transmitted to the conveyor belt 28. In disassembling the vegetable cutting apparatus in cleaning of the conveyor belt 28, or the like, a procedure reverse to the above assembling one can be taken.

To the oneway clutch 30, the middle portion of the rocking bar 41 is connected, and the rocking bar 41 is rocked about the oneway clutch 30, the function of the oneway clutch 30 causing the motion of the rocking bar 41 being transmitted to the drive roller 26 at the time of rocking turning in one direction alone. To the rear end portion of the rocking bar 41 on the motor side, the lower end portion of a tension spring 42, the upper end portion of which is hooked to the inner wall of the casing 4a, is connected, thereby the rear end portion of the rocking bar 41 is always pulled upward.

In a preferred embodiment, to the side wall 24 on the side on which the rocking bar 41 is disposed, an adjuster 43 in the shape of a sector for restricting the rocking angle of the rocking bar 41 is pivotably attached. The adjuster 43 is disposed in a positional relationship in which the peripheral face in the shape of a circular arc thereof is abutted against a back face of the rocking bar 41 in the front end portion thereof, and the pivoting shaft of the adjuster 43 is an eccentric shaft which is away from the center of the peripheral face in the shape of a circular arc thereof. Since the rear end portion of the rocking bar 41 is always pulled by the tension spring 42, the back face of the front end portion thereof is always pressure-contacted with the peripheral face in the shape of a circular arc of the adjuster 43.

Therefore, when the adjuster 43 is eccentrically pivoted, the angle of downward turning of the rocking bar 41, which is abutted against the peripheral face in the shape of a circular arc of the adjuster 43, is changed in accordance with the pivot position of the adjuster 43. In this way, by changing the turning angle of the rocking bar 41, the rotation angle of the oneway clutch 30, to which the rocking bar 41 is fixed, and the drive roller 26 can be controlled. The rotation angle of the drive roller 26 is related to the stroke of the conveyor belt 28, which is intermittently driven, in other words, the cut length of the vegetables. The pivot position of the adjuster 43 can be adjusted during the running of the vegetable cutting apparatus with no need for stopping the running.

The rocking bar 41 is rocked about the oneway clutch 30 with the rear end portion thereof being pressed down by a drive bar 52, which is rocked by the function of a plate cam 51 fixed to the output shaft 9 of the motor 8. The drive bar 52 is pivotable, the one end portion being pivotably attached to the vertical base plate 5, and to the top face of the other end portion thereof, the lower end of the tension spring 54, the upper end of which is hooked to the vertical base plate 5, is hooked, thereby the drive bar 52 being always pulled upward by the tension spring 54. In this way, the middle portion of the drive bar 52 is always abutted against the peripheral face of the plate cam 51, thereby the drive bar 52 functioning as a follower member for the plate cam 51, which is a driving member. In other words, the drive bar 52 is vertically pivoted with the rotation of the plate cam 51, and at the time of downward pivoting, a protruded piece 53 in the shape of a semisphere that is provided at the end portion thereof functions so as to press down the rear end portion of the rocking bar 41.

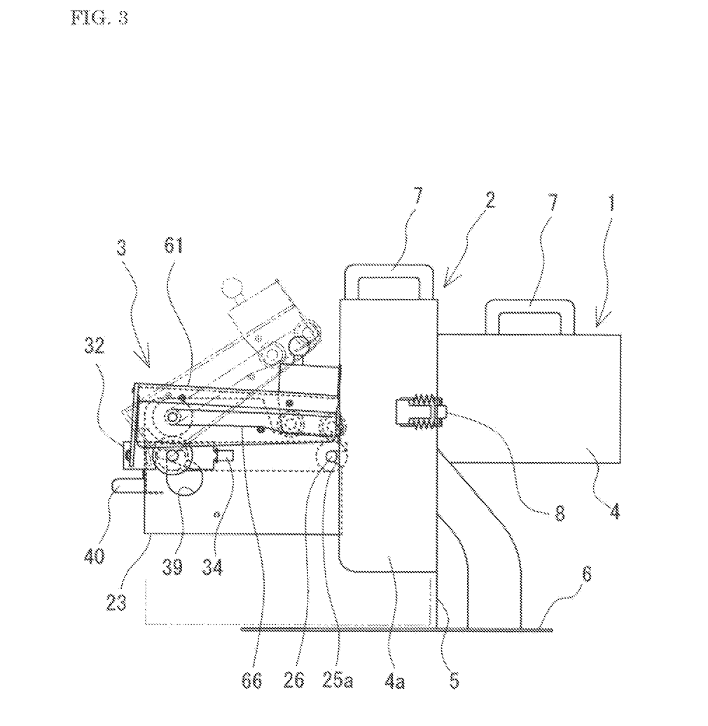

In the embodiment illustrated, along the side wall 25 on the side opposite to the side of the conveyor frame 23 on which the rocking bar 41 is disposed, there is disposed an auxiliary conveying unit case 61 which incorporates an auxiliary conveying mechanism. In the inside of the auxiliary conveying unit case 61, a drive gear 62, which is disposed at the shaft end of the driven roller 27, and a driven gear 63, which is engaged with the drive gear 62, are disposed, and a timing belt 66 is installed between a small gear 64, which is integral and concentric with the driven gear 63, and a small gear 65, which is provided on the shaft of the holding roller 29. The auxiliary conveying unit case 61 is raisably mounted (see virtual lines in FIG. 3).

In the auxiliary conveying mechanism having such a configuration, when the drive gear 62 is intermittently rotated with the driven roller 27 being intermittently rotated, the driven gear 63, which is engaged with the drive gear 62, is intermittently rotated. The intermittent rotation of the driven gear 63 is transmitted to the holding roller 29 through the small gear 64, which is integral with the driven gear 63, the timing belt 66, which is installed on the small gear 64, and the small gear 65, thereby the holding roller 29 being intermittently rotated in a direction reverse to that of the direction of intermittent rotation of the drive roller 26 for feeding forward the vegetables sandwiched between it and the conveyor belt 28 in synchronization therewith.

The vegetable cutting apparatus in accordance with the present invention has the configuration as described above, and the vegetables supplied on the conveyor belt 28 are sandwiched between the conveyor belt 28, which is intermittently moved in a circulatory manner, and the holding roller 29, which is intermittently rotated in synchronization with the movement of the conveyor belt 28, and are advanced toward the cutting unit 2 by one stroke of the conveyor belt 28, and stopped in a position where the tip portion thereof is beyond the round blade 11.

While the vegetables are advanced, the round blade 11 is being revolved in the region which is away from the cutting position of the vegetables (by the function of the cam 51), however, as described above, also thereafter while the vegetables have stopped their advancement, the round blade 11 continues to be revolved, while being rotated, and then before long is brought into contact with the vegetables in standstill for cutting the portion of the vegetables that is beyond the round blade 11. In this way, the vegetable cutting apparatus in accordance with the present invention, the vegetables are smoothly cut in the state in which they are standstill and firmly sandwiched between the conveyor belt 28 and the holding roller 29, thereby a neat and uniform cut end being provided.

As described above, the stroke length of the conveyor belt 28 that corresponds to the cut length of the vegetables can be freely set by adjusting the rocking region for the rocking bar 41, and increasing the size of the rocking region will increase the stroke length. Therefore, by pivoting the adjuster 43, a desired cut length of the vegetables can be set, and the pivoting operation can be made during the running of the vegetable cutting apparatus.

Cutting of the vegetables is performed before the tip portion thereof is abutted against the rotation base plate 16, but even if the tip portion of the vegetables were abutted (which might be caused), the cut length would not be further increased, thereby the vegetables being cut to a substantially uniform length. After completion of the cutting of the vegetables (by one cut), the conveyor belt 28 and the holding roller 29 are operated to further advance the sandwiched vegetables by one stroke, and cause them to wait until the round blade 11 arrives at. Thereafter, the cutting is successively performed by the same action, however, except that the vegetables to be cut must be manually supplied onto the conveyor belt 28, no manual operation is required for automatic progression of the cutting.

In addition, with the vegetable cutting apparatus in accordance with the present invention, a single motor 8 is used as a driving source for performing planetary gear-driving of the cutting means and feed driving of the vegetables in the feeding unit 3, whereby the entire apparatus can be configured to be compact and the maintenance can be made with ease.

Heretofore, the present invention has been explained considerably in detail with reference to the most preferred embodiment, however, needless to say, a wide variety of embodiments can be configured without departing from the spirit and scope of the present invention. Therefore, the present invention will not be restricted to any specific embodiment, provided that it is not departed from the scope of the invention as defined by the appended claims.

### REFERENCE SIGNS LIST

1: rotation driving unit
2: cutting unit
3: feeding unit
4: casing
5: vertical base plate
11: round blade
12: gear case
13: sun gear
14: planetary gear
23: conveyor frame
24, 25: side walls
26: drive roller
27: driven roller
28: conveyor belt
29: holding roller
30: oneway clutch
31, 32: seizing member
34: rectangular hole
35: leaf spring
36: seizing hole
37: front plate
41: rocking bar
42: tension spring
43: adjuster
51: plate cam
52: drive bar
54: tension spring

1. A vegetable cutting apparatus, comprising:
a rotation driving unit having a rotation driving means;
a cutting unit having a cutting means for cutting charged vegetables, being planetary gear-driven by the rotation driving means; and
a feeding unit having an intermittent feeding means for intermittently supplying the vegetables to be cut to the cutting means,
the feeding unit including a conveyor frame horizontally extending from the cutting unit;
a drive roller and a driven roller, being installed across side walls of the conveyor frame;
a conveyor belt, being installed on the drive roller and the driven roller in a tightened state; and
a holding roller, being disposed above the conveyor belt on the rear side thereof with a clearance to the conveyor belt being held,
to the drive roller, a oneway clutch being mounted, and with rocking turning of a rocking bar disposed on the oneway clutch, the drive roller being intermittently rotation-driven, thereby the vegetables placed on the conveyor belt being made intermittently feedable toward the cutting means, and feeding of the vegetables at the time of cutting operation by the cutting means being made stoppable.

2. The vegetable cutting apparatus according to claim 1, wherein the middle portion of the rocking bar is connected to the oneway clutch, the inner end portion of the rocking bar being always pulled upward by a tension spring to be abutted against a drive bar, the drive bar being rocked by following a plate cam fixed to an output shaft of the rotation driving means, and the rocking bar being rocked about the shaft of the oneway clutch as the drive bar being rocked, thereby being engaged with the drive roller at the time of rocking in one direction for intermittently moving the conveyor belt.

3. The vegetable cutting apparatus according to claim 2, wherein the plate cam functions such that, at the time of cutting operation by the cutting means, advancement of the conveyor belt is stopped.

4. The vegetable cutting apparatus according to claim 1, wherein, along a side wall on the side opposite to the side of the conveyor frame on which the rocking bar is disposed, an auxiliary conveying mechanism is disposed such that, through the auxiliary conveying mechanism, an intermittent rotation operation of the driven roller is transmitted to the holding roller.

5. A vegetable cutting apparatus according to claim 1, wherein, on the side wall on the side on which the rocking bar is disposed, an adjuster in the shape of a sector having a peripheral face in the shape of a circular arc that is abutted against a back face of the rocking bar in the front portion thereof, and being eccentrically pivoted is disposed, and by eccentrically pivoting the adjuster, the rocking region for the rocking bar is adjustable.

6. The vegetable cutting apparatus according to claim 1, wherein a seizing member which, in one end portion, is provided with a folded piece to slidably engage with a rectangular hole formed in the side wall, and in the other end portion, is provided with a seizing hole for seizing one end portion of a leaf spring to be disposed across the tip portions of the side walls, and in which, in the middle portion, a shaft supporting groove for seizing the shaft of the driven roller is formed is disposed along the side wall, and the shaft of the driven roller is pulled through the seizing member by the function of the leaf spring, thereby the tightened state of the conveyor belt is capable of being maintained.
